(19) United States
(12) Patent Application Publication
(10) Pub. No.: US 2007/0300058 A1
(43) Pub. Date: Dec. 27, 2007

(54) Credential Provisioning For Mobile Devices

(75) Inventors: Janne P. Takala, Tempere (FI); Rauno Tamminen, Tempere (FI); Lauri Paatero, Helsinki (FI); Antti Kiiveri, Oulu (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/425,572

(22) Filed: Jun. 21, 2006

(51) Int. Cl. H04L 9/00

(52) U.S. Cl. 713/155

(57) ABSTRACT

A method and system for determining rights to access digital content at a mobile communication device is described. A mobile communication device is manufactured with a credential store that maintains credentials associated with the mobile communication device. After manufacturing of the mobile communication device, a player component is installed onto the mobile communication device. With a request for digital content to be used or distributed by the player component, one or more credentials of the mobile communication device are confirmed for accuracy. If accurate, the mobile communication device receives the requested digital content for use and distribution.

### FIELD OF THE INVENTION

The present description relates generally to mobile communication systems. More specifically, the present invention relates to digital rights management and security in mobile devices.

### BACKGROUND

With the proliferation of downloadable music and other data to a wireless terminal device comes the increased problem of addressing illegal transactions and maintaining rights in the content that is downloaded. Digital Rights Management (DRM) systems are one tool used to control the distribution of digital media content. A DRM system governs how content is used and distributed and allows the development of new end-user features and new kinds of mobile content services for content providers, service developers, operators, and service providers.

DRM systems, such as OMA DRM2.0 (second generation DRM standard by the Open Mobile Alliance (OMA)) and WMDRM (Windows Media DRM by Microsoft® Corporation of Redmond, Wash.) require identification of a client, e.g., player device, using credentials. The credentials are used to verify that the player will obey and enforce rights associated with the content. The content, e.g. music, is tied to the specific credentials and thus to a specific client device or group of client devices. Client devices include audio players, video players, and combinations of both among other types of players. Nokia® 3600 Video Player/Recorder by Nokia Corporation of Espoo, Finland and Media Player by Microsoft® Corporation of Redmond, Wash. are two such example players.

Traditionally, the generation of credentials for client devices occurs by way of one of two different methods. In one method, credentials are generated during the manufacturing phase of the client device. An example system that implements this first method includes the OMA DRM2.0 system. Utilizing this first method, client devices can be identified, and thus revoked, as individuals. In addition, since there is no common credential, e.g., a group key, present in all client devices, the level of security is much higher than generation of credentials at run-time as described below. However, by requiring the need to install credentials at the time of manufacturing, there is a corresponding cost and resource time associated with the manufacturing of the client devices.

In a second method, the client device credentials are generated during a run-time, i.e., as the client player is run for the first time. An example system that implements this second method includes the Microsoft® WMDRM system by Microsoft® Corporation of Redmond, Wash. Utilizing this second method, fewer resources are needed at the time of manufacturing. Therefore, it is possible to install the player after device manufacturing, and since the player then has the necessary credentials, such as a group key, the client device may operate to receive DRM content. This type of method helps prevent illegal software copy and use. A feature version of a license allows for the sale of restricted versions of the software. In this method, a feature license and the DRM component are provided together with the software when the software is bought and these licenses control in which device features can be used, for how long the features can be used, and which features can be used. In general, generic hardware devices are manufactured and features of a given software are provided with the later obtained software.

However, when utilizing such a method, client device revocation can only be done based on the group key, i.e., it is only possible to revoke all the client devices that share the group key, not individual devices. In addition, because a common group key has to be present in all the client devices, it is possible to reverse-engineer the client device and determine the corresponding group key. As such, security of content is lessened.

### SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Aspects of the present invention provide a high security solution for distributing and generating device specific credentials which are needed in DRM systems, such as in a Windows Media DRM (WMDRM) system by Microsoft® Corporation of Redmond, Wash. In accordance with aspects of the present invention, the benefits of credential provisioning during manufacturing in addition to generic credentials for post player installation are achieved without compromising the security level.

In accordance with at least one aspect of the present invention, credentials may be installed during the manufacturing process without a player component being included in the sold client device. The player component may then be distributed/sold separately after a customer has purchased the client device. Credentials installed during manufacturing are unique to each device. Manufacturing the devices without credentials requires a common secret which is shared by multiple devices. Compromising the common secret, such as by reverse-engineering, compromises all the devices sharing that secret. With credentials installed during manufacturing, each device has a unique secret. Compromising the secret of one device does not affect other devices. Compared to a common secret, such a device specific secret creates a higher security in the device.

In accordance with at least one other aspect of the present invention, generic, as opposed to specific, DRM scheme credentials may be utilized in a client device. As such, new DRM schemes may be later developed and client devices may be upgraded at a later time. Thus, a manufacturer of the client device may have a new after market sales opportunity.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an example functional architecture of a Digital Rights Management system;

FIG. 2 is a flowchart of an illustrative method for determining rights to access digital content for a mobile communication device in accordance with at least one aspect of the present invention;

FIG. 3 is a flowchart of an illustrative method for determining whether a player component is authorized to be installed onto a mobile communication device in accordance with at least one aspect of the present invention;

FIG. 4 is a flowchart of an illustrative method for determining whether a player component is allowed to use credentials associated with an electronic device in accordance with at least one aspect of the present invention;

FIG. 5 is an illustrative flowchart of a method for determining whether a mobile communication device is configured to permit installation of a player component in accordance with at least one aspect of the present invention; and

FIG. 6 is an illustrative flowchart of a method for changing Digital Rights Management functionality in accordance with at least one aspect of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

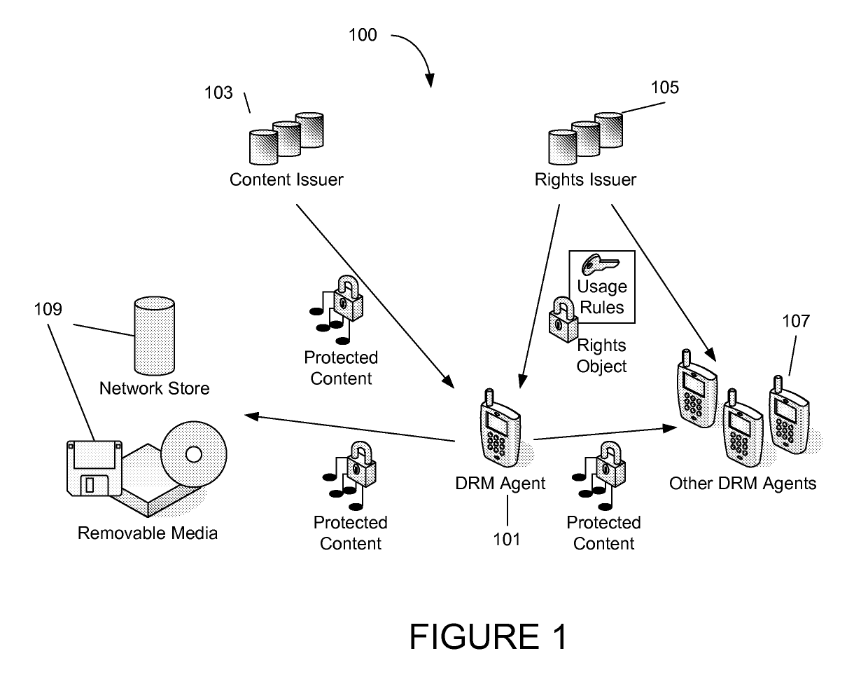

FIG. 1 illustrates an example functional architecture of a Digital Rights Management (DRM) system 100. A DRM agent 101 may be a mobile communication device that has a player component and device specific credentials stored in the device. Alternatively, the device credentials may be generated the first time a user operates the player component. Based upon the rights of the DRM agent 101 received from a rights issuer 105, DRM agent 101 receives protected content 103 from a content issuer 103. For example, DRM agent 101 may desire to download a music data file.

Upon receipt of the protected content from content issuer 103, DRM agent 101 may utilize the protected content based upon the rights obtained from rights issuer 105. For example, DRM agent 101 may be allowed to distribute the protected content to other DRM agents 107, but may be restricted from sending to removable media or network store 109. A DRM architecture 100 defines, creates, and manages credentials for various types of DRM agents 101/107 in the system.

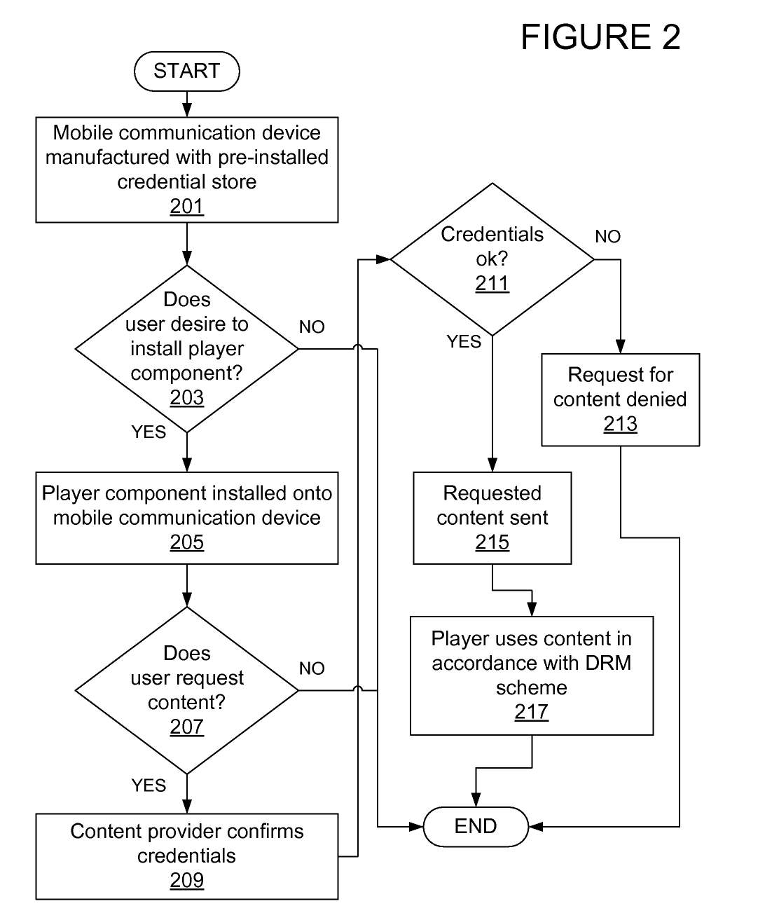

In accordance with aspects of the present invention, credentials may be installed during the manufacturing process of a client device without a player component being included in the client device when sold to consumers. The player component may then be distributed/sold separately after a customer has purchased the client device. FIG. 2 is a flowchart of a method for determining rights to access digital content for a mobile communication device in accordance with at least one aspect of the present invention.

The process starts at step 201 a mobile communication device is manufactured with a credential store. Software within a mobile communication device, such as trusted software within the device, maintains the client device credentials. The software within the mobile communication device is configured to not include any feature licenses. Feature licenses are integrated into hardware or firmware components of the mobile communication device. As such, feature licenses and software are not provided together. A credential store and credentials are placed in the client device during the manufacturing process, i.e., they are pre-installed. At step 201, the mobile communication device is manufactured without a player component installed. Then, a player may be installed later, i.e., post manufacturing. In one example, the player may be installed by a user after purchasing the player. Having purchased the mobile communication device and proceeding to step 203, a determination is made as to whether a user desires to install a player component onto the mobile communication device. If not, the process ends. If the user does desire to install a player component, the process moves to step 205 where the player component is installed onto the mobile communication device. As should be understood by those skilled in the art, any number of methods may be utilized to install a player component, including downloading and installing from a web page or from a removable storage device.

At step 207, a determination is made as to whether the user requests content for use with the player component. If not, the process ends. If the user does request content for use with the player component, the process moves to step 209. At step 209, the content provider that receives the request for the user desired content confirms the credentials of the mobile communication device. At step 211, a determination is made as to whether the credentials are correct, i.e., whether the user is authorized to obtain the requested content. The confirmation of the credentials and determination as whether they are correct is specified by the DRM scheme being used. A content provider performs the algorithm on two parts of the credential using two different keys and compares the results to other parts of the credential. A digital signature part of the credential from the credential authority certifies that the provided credentials are valid for this credential domain. A digital signature from the user as part of the request verifies that the author of the request actually possesses these particular credentials. Then, the content provider may check from a credential revocation list, e.g., a black list, provided by the credential authority, to determine whether the particular credential is known to not be trusted.

If the credentials of the mobile communication device are not correct in step 211, the process moves to step 213 where the request for the content is denied before the process ends. A subsequent message may be sent to the mobile communication device reflecting such. As the process is specific to the DRM scheme utilized, the message may vary. In one example, a player application may provide an error message for the user. For example, if the trusted software determines that a player component is not allowed to be installed, the software may prevent the use of the credentials. In such a case, step 211 answers no and the process moves to step 213. If the credentials are determined to be correct in step 211, the process moves to step 215 where the requested content, such as an audio file, video file, text data, web page, video with audio, is sent to the mobile communication device. At step 217, the player component on the mobile communication device uses the content in accordance with the DRM scheme associated with the mobile terminals device, the player component, and/or the content itself.

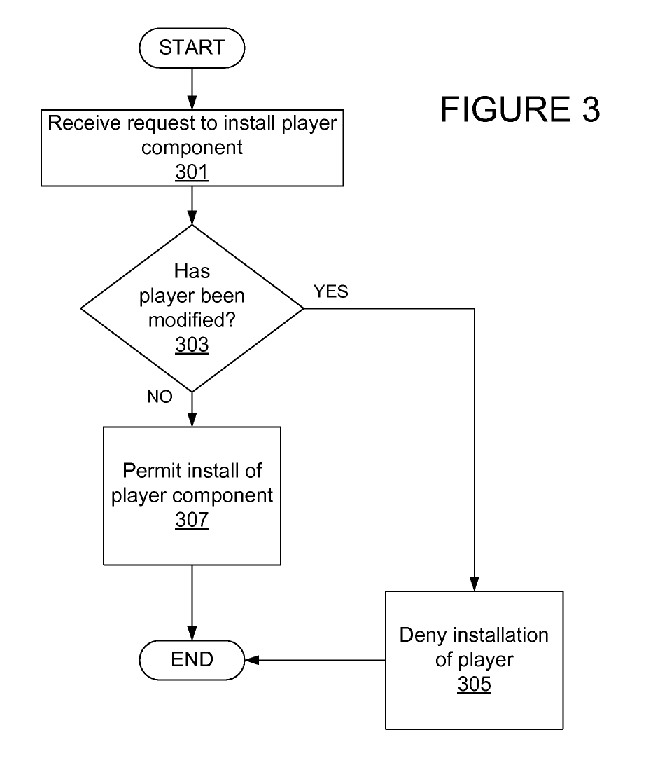

In addition, a separate security mechanism may be used to determine whether the player may be installed, thus ensuring that modified players do not work unless authorized. FIG. 3 is a flowchart of a method for determining whether a player component is authorized to be installed onto a mobile communication device in accordance with at least one aspect of the present invention. The process starts at step 301 where a request to install a player component is received.

At step 303, a determination is made as to whether the player component to be installed has been modified, e.g., is an unauthorized copy that cannot be trusted. If not, the process moves to step 307. Those skilled in the art should appreciate that there are a number of manner in which this determination may be made. For example, code signing, or checksum data, may be used to determine if the player component has been modified.

At step 305, installation of the player component is denied before the process ends. If a player component is unmodified at step 303, the process moves to step 307 where installation of the player component is permitted. With respect to step 307, the credentials of an electronic device have no role.

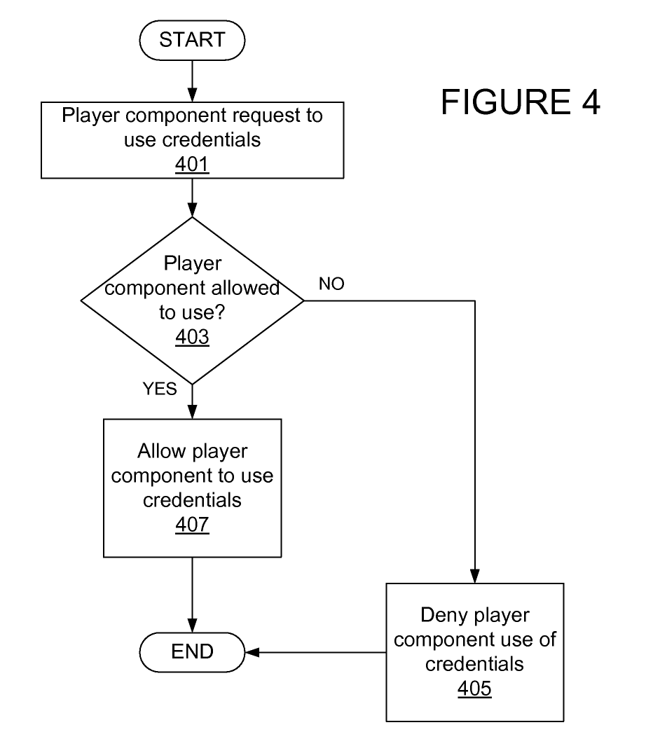

FIG. 4 is a flowchart of a method for determining whether a player component is allowed to use credentials associated with an electronic device in accordance with at least one aspect of the present invention. FIG. 4 illustrates features of step 209 in FIG. 2. In step 209, a player component application requests the use of credentials. This initiates the process in FIG. 4. Credentials are controlled by the trusted software in the electronic device. The trusted software may determine whether the player component is authorized to be used. In accordance with aspects of the present invention, authorization information may be maintained in a number of manners. In one manner, the credentials may have the authorization information, i.e., if the credentials are in the electronic device, then use of the credentials by a player component is allowed. Another manner is by use of a separate control mechanism, such as with a certificate. In accordance with aspects of the present invention, such a separate control mechanism may be controlled separately as well. For example, credentials may be provisioned for multiple electronic devices, but the separate control certificate may be modified and changed later. The trusted software of the electronic device uses the control mechanism and it may deny the player component usage of the credentials.

In step 401 of FIG. 4, a player component requests authorization to use the credentials associated with an electronic device. At step 403, a determination is made as to whether the player component is authorized to use the credentials. As described above, this determination may be made by trusted software within the electronic device. If the player component is determined to not be allowed to use the credentials, the process moves to step 405 where a denial of use of the credentials by the player component is made. If the player component is allowed to use the credentials in step 403, at step 407, the player component is allowed to use the credentials as dictated by the trusted software.

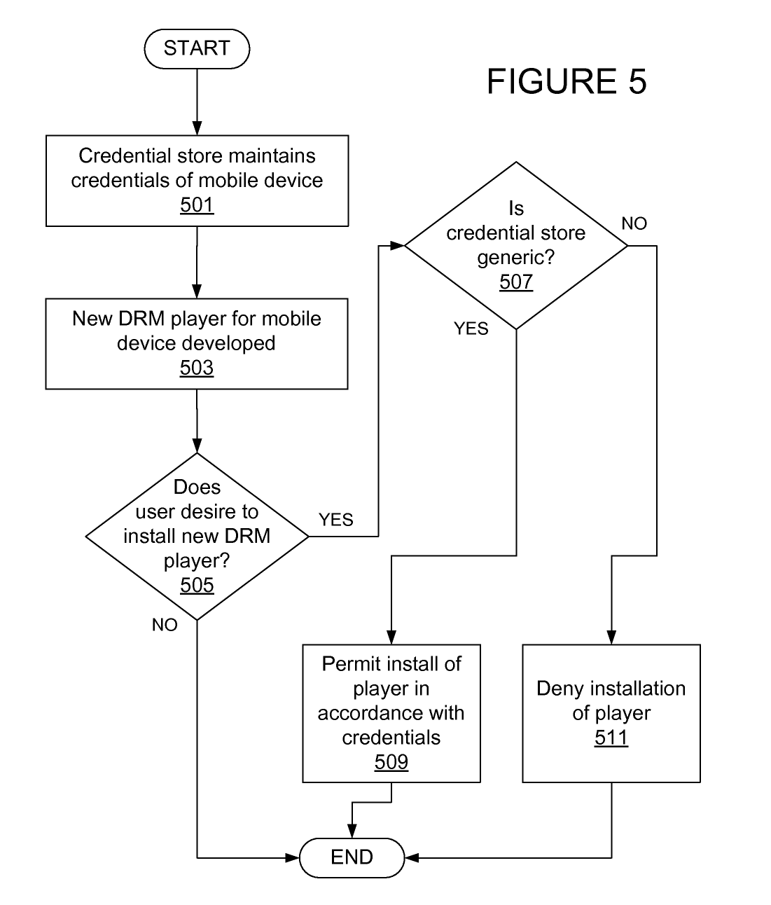

In accordance with others aspects of the present invention, generic, as opposed to specific, DRM scheme credentials may be utilized in a client device. As such, new DRM schemes may be later developed and client devices may be upgraded at a later time. Thus, a manufacturer of the client device may have a new after market sales opportunity. FIG. 5 is a flowchart of a method for determining whether a mobile communication device is configured to permit installation of a player component in accordance with at least one aspect of the present invention.

The process starts at step 501 where a credential store in a mobile communication device maintains the credentials of the mobile communication device. At step 503, a new Digital Rights Management (DRM) player component is developed. For example, Company XYZ may develop a new video player for viewing video data on a mobile communication device. At step 505, a determination is made as to whether a user of the mobile communication device desires to install the new DRM player component. If not, the process ends. If the user does desire to install the new DRM player component, the process moves to step 507.

At step 507, a determination is made as to whether the credential store is a generic credential store, thus allowing later developed player components to be recognizable for installation purposes. If the credential store is generic, at step 509, installation of the new DRM player component is permitted before the process ends. Else, if the credential store is not generic, installation of the player component is denied in step 511 before the process ends. In operation, because the credentials are generic in configuration, new use cases may be defined for existing credentials. In accordance with one example of the present invention, OMA DRM2.0 may be a credential store. For an OMA DRM player in S60 SW, a common configuration certificate may be used to control if the player component may be installed.

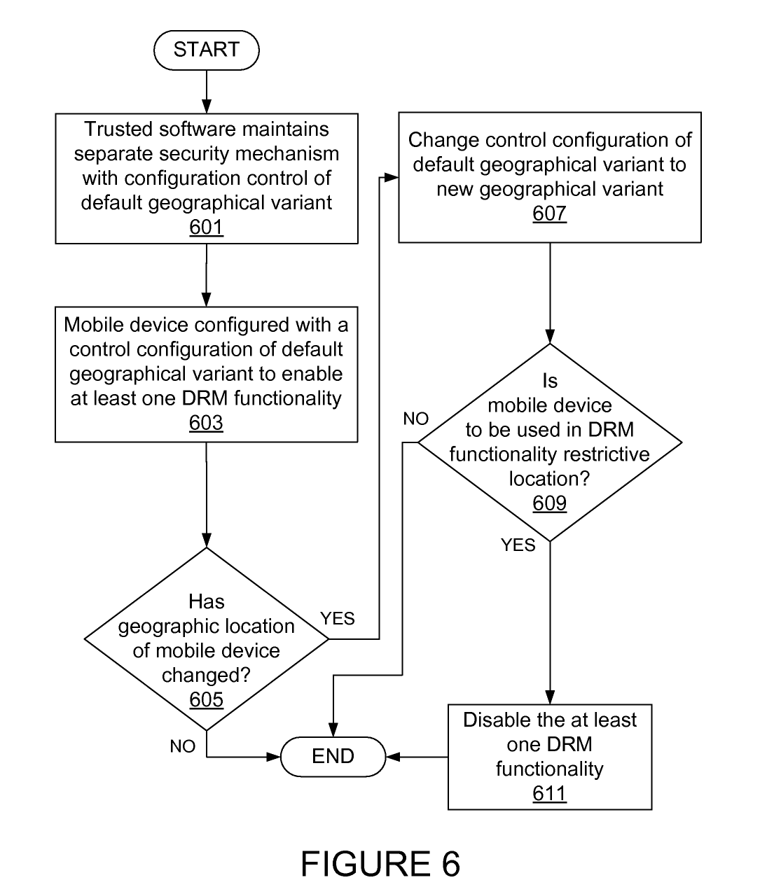

FIG. 6 is an illustrative flowchart of a method for changing Digital Rights Management (DRM) functionality in accordance with at least one aspect of the present invention. FIG. 6 illustrates changing DRM functionality based upon a variant that identifies a country of operation. The method starts at step 601 where trusted software within a mobile device maintains a separate security mechanism. The separate security mechanism is a configuration control for the Digital Rights Management (DRM) functionalities of the mobile device. The separate security mechanism includes a geographical variant. The geographical variant is an identifier as to whether one or more DRM functionalities need to be changed in response to a change in geographical location. For example, legislation in some countries may prohibit one or more DRM technology functionalities for devices. As such, a mobile device operating with DRM functionalities in a first country may require one or more of the functionalities disabled or changed if used in a country prohibiting DRM technology.

Proceeding to step 603, a mobile device is configured with a control configuration of a default geographical variant to enable at least one DRM functionality. For example, a default device may have all DRM functionalities enabled with a geographical variant of default geographical location of a first country. At step 605, a determination is made as to whether the geographic location of the mobile device has changed. Any of a number of different methods may be used to determine a geographic location. For example, for a mobile telephone device, when activated and connecting to a local cell tower, a packet received from the cell tower may specify the country of operation. If the geographic location of the mobile device has not changed in step 605, the process ends. If the geographic location has changed, the process moves to step 607.

In step 607, the control configuration of the default geographical variant is changed to a new geographical variant corresponding to the new geographical location of the mobile device. For example, if the new geographical location of the mobile device is a country that prohibits the use of DRM technology in a mobile device, the control configuration of the mobile device is changed to have a geographical variant corresponding to the DRM prohibitive country. At step 609, another determination is made as to whether the mobile device is to be used in a DRM functionality restrictive geographical location. If the mobile device is not being used in a geographical location that restricts DRM technology in step 609, the process ends. If the mobile device is being used in a DRM functionality restrictive geographical location, the process moves to step 611 where the at least one DRM functionality is disabled before the process ends.

It should be understood by those skilled in the art that the present invention is not so limited to geographical locations with respect to different countries. In addition, in accordance with aspects of the present invention, a geographical variant may alternatively be a user variant where the user variant defines who is using the mobile device. As such, if a mobile device is operated by a new user, such as in step 605 switching from “has geographic location of mobile device changed” to “has user of mobile device changed,” the control configuration with respect to DRM functionalities may be changed to reflect the new user. A first user may have certain allowed DRM functionalities enabled while a second user may have more, fewer, and/or different functionalities enabled for use.

In still another embodiment of the present invention, the geographical variant example with respect to FIG. 6 may alternatively be an operator variant where the operator variant defines the communication service provider for the mobile device. As such, if a mobile device roams from a first communication service provider network to a second communication service provider network, the control configuration with respect to DRM functionalities may be changed to reflect the new operator.

In another embodiment of the present invention, a certificate that enables/disables one or more DRM functionalities may be installed during manufacturing or maintenance. Such a certificate may be configured to prevent the ability to change DRM functionality within the mobile device. Such a certificate may be operator, such as Orange France, Vodafone France, Vodafone UK, and/or country specific. If such a certificate is residing in a Vodafone UK variant mobile device that enables DRM functionality and the mobile device is then used in another country, e.g., roaming in a Vodafone France network, DRM functionality may be configured to operate normally as if the mobile device was still in operation in a Vodafone UK network. Therefore, a certificate that disables DRM one or more functionalities prevents such use irrespective of the country and/or operator in which the mobile device is being used.

The following example provides an illustrative implementation of certain aspects of the present invention. Company A has invested a great deal of time and money in development of new content, such as a music album, and desires to ensure that the content is protected with respect to use and distribution in accordance with certain rules and procedures. Company B is a mobile communication device, such as a mobile telephone, manufacturer. Company B manufactures their mobile communication devices with a credential store pre-installed.

Company B and/or some other company sell(s) a player component for use on the mobile communication device of Company B. The player component is configured to be installed after manufacturing of the mobile communication device. A user of the mobile communication device requests content corresponding to the music album of Company A. If the credentials of the mobile communication device are correct with respect to the player component, the user receives the content and can use or distribute the content as permitted. With the pre-installed credentials, revocation of the rights of individual mobile communication devices may be revoked without use of a group key or other type of global identifier. For example, a content provider may prevent creation of content for a device by creation of a revocation list, e.g., a black list, or those devices not authorized to receive content. As such, there is no group key associated with the mobile communication device that may be reverse-engineered.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method for determining rights to access digital content at an electronic device, the method comprising:
configuring an electronic device with a credential store during manufacturing of the electronic device;
installing a player component after manufacturing of the electronic device;
confirming whether one or more credentials of the electronic device in the credential store are accurate;
upon confirming the one or more credentials are accurate, receiving the requested digital content from the content provider.

2. The method of claim 1, further comprising receiving a request to install the player component.

3. The method of claim 2, further comprising:
determining whether the player component is a modified player component; and
permitting the installation of the player component.

4. The method of claim 3, wherein the step of determining whether the player component is a modified player component includes use of a signed code.

5. The method of claim 3, wherein the step of determining whether the player component is a modified player component includes use of checksum data.

6. The method of claim 3, wherein the step of determining whether the player component is a modified player component is performed by trusted software associated with the electronic device.

7. The method of claim 2, further comprising:
determining whether the player component is a modified player component; and
denying the installation of the modified player component.

8. The method of claim 1, further comprising transmitting a request for digital content from a content provider.

9. The method of claim 8, wherein the step of confirming includes using a control mechanism to allow or deny the use of one or more credentials.

10. The method of claim 9, wherein the step of confirming is based upon a certificate.

11. The method of claim 10, further comprising a step of replacing the certificate with a new certificate.

12. The method of claim 1, further comprising:
configuring a control configuration with a default variant in the electronic device; and
changing the default variant of the control configuration to a new variant,
wherein the default variant corresponds to at least one first digital rights management functionality and the new variant corresponds to at least one second digital rights management.

13. The method of claim 12, further comprising determining whether the electronic device has changed a geographical location.

14. The method of claim 12, wherein the default and new variants correspond to first and second geographical locations.

15. The method of claim 12, wherein the default and new variants correspond to first and second operators of the electronic device.

16. The method of claim 1, further comprising:
configuring a control configuration with a default variant in the electronic device; and
operating the player component based upon the control configuration,
wherein the default variant corresponds to at least one digital rights management functionality based upon a certificate.

17. An electronic device comprising:
a credential store configured to maintain credentials associated with the device;
a memory space configured to maintain software associated with a player component, the software installed after manufacturing of the device;
a memory configured to maintain trusted software for controlling installation of the player component; and
the software associated with the player component configured to request and use digital content from a content provider.

18. The electronic device of claim 17, wherein the credential store includes one or more credentials associated with the device and one or more credentials associated with the player component.

19. The electronic device of claim 17, wherein the credentials are used determine whether the player component is permitted to be installed onto the device.

20. The electronic device of claim 17, wherein the trusted software determines whether the player component is a modified player component.

21. The electronic device of claim 17, wherein the software associated with a player component is further configured to use the digital content in accordance with the credentials associated with the device.

22. The electronic device of claim 21, wherein the electronic device is a mobile communication device.

23. The electronic device of claim 17, wherein the electronic device is a mobile communications device.

24. A system for determining rights to access digital content comprising:
an electronic device including:
a credential store configured to maintain credentials associated with the electronic device; and
a memory configured to maintain computer-executable instructions for software associated with a player component;
a memory configured to maintain computer-readable instructions for trusted software for controlling installation of the player component;
the player component configured to request and use digital content, the player component being installed after manufacturing of the electronic device; and
a content provider configured to receive a request for digital content from the player component, confirm the accuracy of the credentials in the credential store, and to respond to the request for digital content.

25. The system of claim 24, wherein the player component is determined to be an unmodified player component and the response to the request is the requested digital content.

26. The system of claim 24, wherein the credential store includes one or more credentials associated with the device and one or more credentials associated with the player component.

27. The system of claim 24, wherein the software associated with a player component is further configured to use the digital content in accordance with the credentials associated with the device.

28. The system of claim 24, wherein the credential store is generic credential store configured to be upgraded.

29. An electronic device comprising:
memory, the memory including:
means for maintaining credentials associated with the electronic device;
means for maintaining software associated with a player component, the software installed after manufacturing of the electronic device; and
means for determining whether the player component is permitted to be installed onto the electronic device.

30. The electronic device of claim 29, wherein credentials include one or more credentials associated with the electronic device and one or more credentials associated with the player component.
